(19) United States
(12) Patent Application Publication
(10) Pub. No.: US 2020/0348156 A1
(43) Pub. Date: Nov. 5, 2020

(54) PRECONDITIONED AIR TESTER

(71) Applicant: Jim Dorworth, Sarasota, FL (US)

(72) Inventor: Jim Dorworth, Sarasota, FL (US)

(21) Appl. No.: 16/401,120

(22) Filed: May 2, 2019

(51) Int. Cl. G01D 21/02; G01F 1/76; G01M 3/26

(52) U.S. Cl. CPC G01D 21/02; G01M 17/00; G01M 3/26; G01F 1/76

(57) ABSTRACT

The present invention is in the field of end of the line testers. More specifically, the present invention is a preconditioned air tester

### BACKGROUND OF THE INVENTION

### Field of the Invention

The present invention is in the field of end of the line testers. More specifically, the present invention is a preconditioned air unit (PCA) end of the hose tester.

### Background of the Invention

The present invention is a pre-conditioned air unit's end of hose tester providing the point of use (POU) units that are actual discharge temperature, actual air speed, flow/velocity and an adjustable back pressure restrictor allowing the air discharge to be measured in inches of water-column/pressure restriction being applied, providing the ability to add on additional ports for connection of other manometer and hot stick gage devices for additional testing.

The present invention is a point of use (POU) pre-conditioned air unit tester with the ability to create a load or adjustable back-pressure restricted air flow designed to be utilized as a maintenance analyzing tool by engineers, technician's or maintenance. Also, aircraft ground support (GSE) personal or HVAC mechanics.

The present invention was developed to assist engineering, maintenance both: Aircraft, Ground Support Equipment Mechanics/Technicians and HVAC mechanics with their task of analyzing and determine if the air flow and the values that are being supplied by a pre-conditioned air (PCAir) unit at the end of the hose are to the units and aircrafts requirements needed to cool or heat the air craft that is being serviced by the POU PCAir unit.

This tester enables a load or back pressure to the POU per-conditioned (PC) air units conditioned air discharge status that is being provided at the end of the hose are to the manufacturers design and advertised requirements of the PCAir unit's product to the aircraft type being serviced by the pre-conditioned POU unit.

The present invention is connected to the aircraft supply hose utilizing the end of hose's 8″ aircraft inlet adapter. The aircraft adaptor connects directly to the tester no hose disassembly is required. The present invention tester enables the maintenance technician to read gages to analyze and determine if the POU PCA units air discharge being provided are within the aircrafts design requirements and PCA units settings for the external air supply connected to the aircraft.

Utilization of this test devise eliminates the need for special or additional equipment as there is no need for tools no need for hose separating no requirement for removing sections of hose for testing. Adjust and restrict the POU PCA units discharge air through the present invention devices adjustable restrict or nozzle to obtain the desired/aircraft type of restricted airflow required—Inches of H2O (in.H2O WC) as required by the aircraft type and the PCAir units designed criteria.

The present invention provides a visual meter reading of Air flow via an air speed gauge through differential pressure or viscosity reading or hot stick reading thru added ports of the restricted air flow being supplied. Air discharge temperature displayed on a thermometer that may be analog or digital.

Displays a true discharge temperature of the air being supplied from the POU air unit the end of the hose at the aircraft inlet adapter. The present invention can be used on all POU air units using a discharge hose via an 8″ Inlet adapter regardless if it is a fixed, mobile or central system. The pre-conditioned air tester has ability for achieving air discharge back pressure restricted air flow settings by the user with adjustable restricted airflow ranges in varied inches of H2O. Testing examples of restricted air flows are given/provided but the air flow is able to be adjusted to meet the desired aircraft manufacturers suggested pressures for the specific type of aircraft and the PCA units manufacturers specific designed of the units' operation and air discharge at the end of the hose.

Suggested testing ranges are provided on the units' labeled operational placards and are subject to change or replacement by the owner. Commuter aircraft at: 5-8 in H20. Narrow body at: 10-20 in H2O. Wide Body at: 18-25 in H2O. Jumbo Aircraft have 2 hoses supplied from the POU PCAir unit and 2 separate test devices are required to be used in test at the same time to achieve a balanced test.

This testing device is not intended for proofing, certifying or verifying any POU PCA unit manufactures or central systems units published or required operational performance design or performance criteria of the units' certification or compliance for operational criteria of ASHREA for supplying condition air from the POU conditioned air unit for supporting aircraft manufacturers design requirement of the aircrafts' planning manual.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a preconditioned air tester, in accordance with one embodiment of the present invention.

FIG. 2 illustrates a preconditioned air tester, in accordance with one embodiment of the present invention.

FIG. 3 illustrates a preconditioned air tester, in accordance with one embodiment of the present invention.

FIG. 4 illustrates a preconditioned air tester, in accordance with one embodiment of the present invention.

FIG. 5 illustrates a preconditioned air tester, in accordance with one embodiment of the present invention.

FIG. 6 illustrates a preconditioned air tester, in accordance with one embodiment of the present invention.

FIG. 7 illustrates a preconditioned air tester, in accordance with one embodiment of the present invention.

FIG. 8 illustrates a preconditioned air tester, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

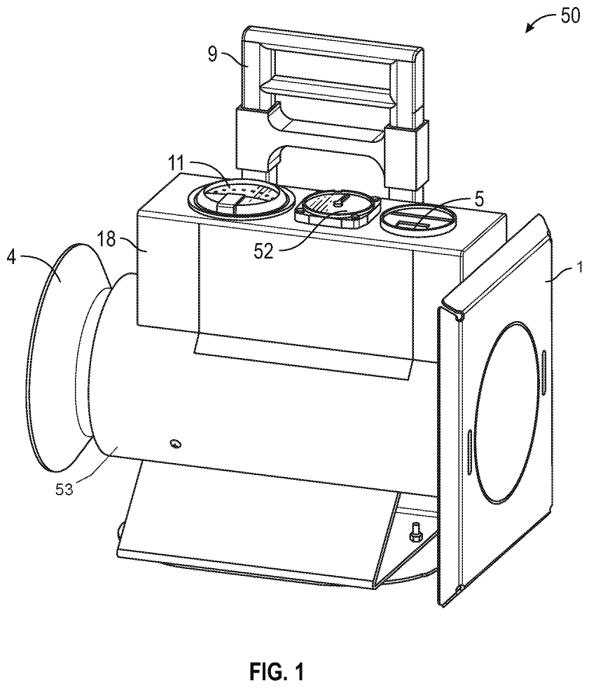

Referring now to FIG. 1, illustrated is an preconditioned air tester, in accordance with one embodiment of the present invention. In FIG. 1, illustrated is a preconditioned air tester 50 with a cart 9 to provide modality to the preconditioned air tester 50. On top of a cover 18 is air pressure gauge 11, air speed gauge 52 and temperature gauge 5. A cone or adjustable restricting cover plate 4 is opposite a body weldment 1. Additional ports can be provided and installed in tube 53 by the customer requests for utilizing manometers/flowmeter and hot stick meters for additional readings. Gages meters or test devices can be on the test device or on a pendant control box or air data manometers and multimeters for specific testing requirements and needs.

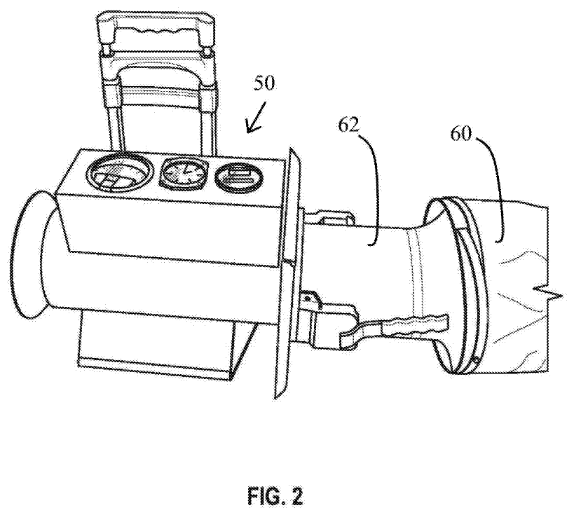

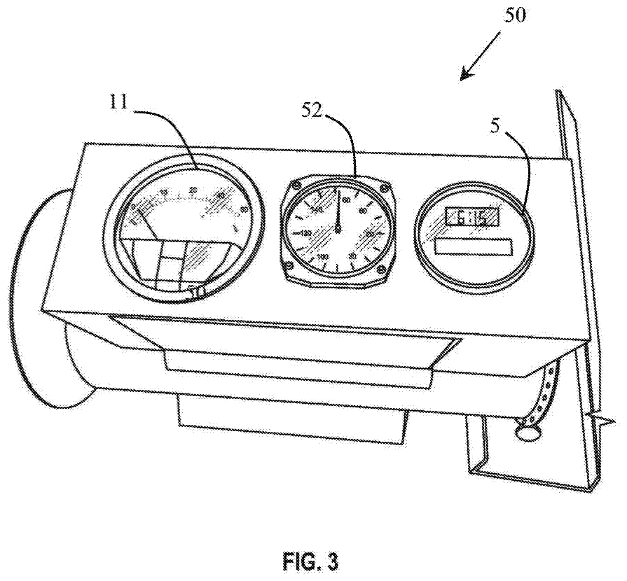

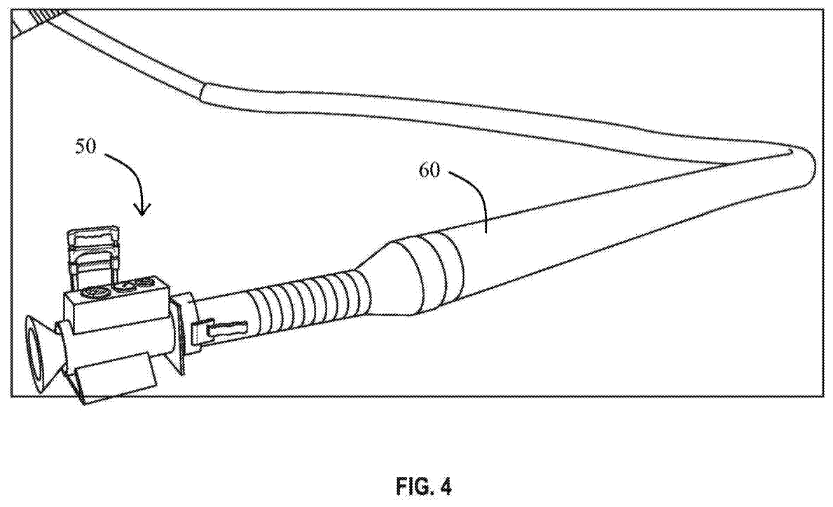

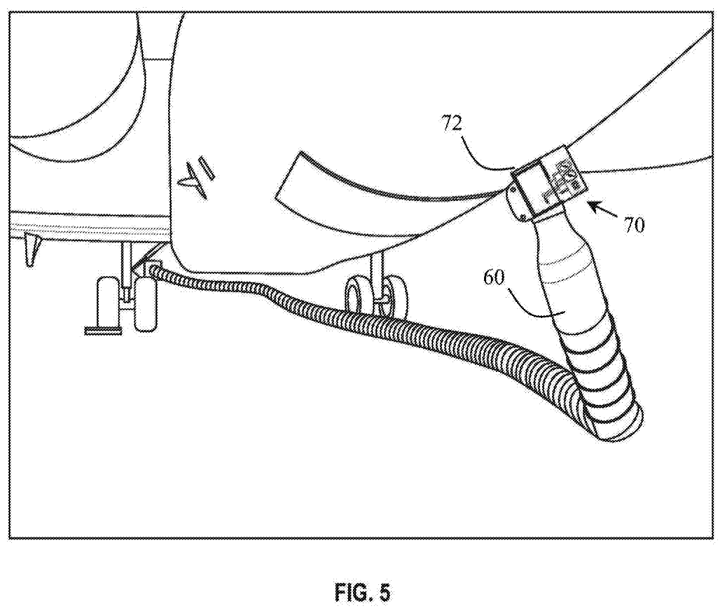

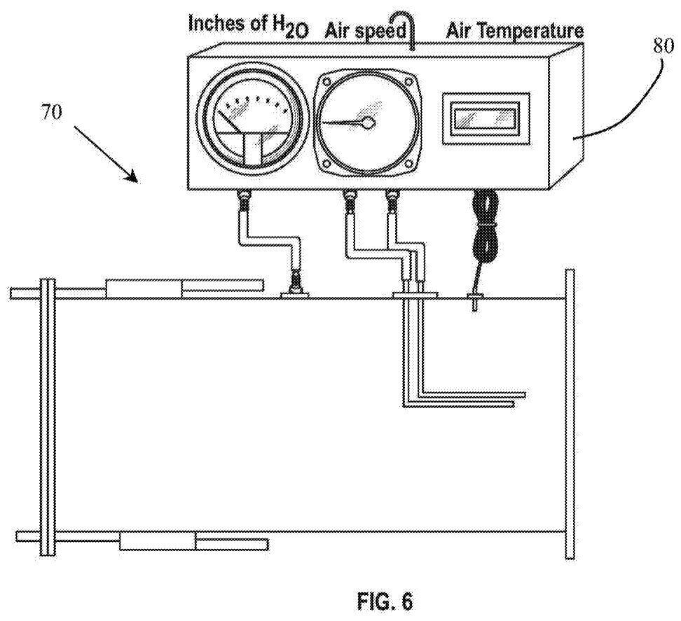

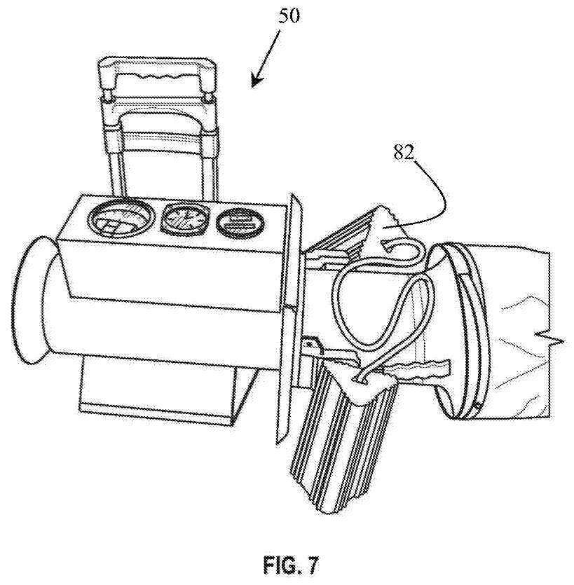

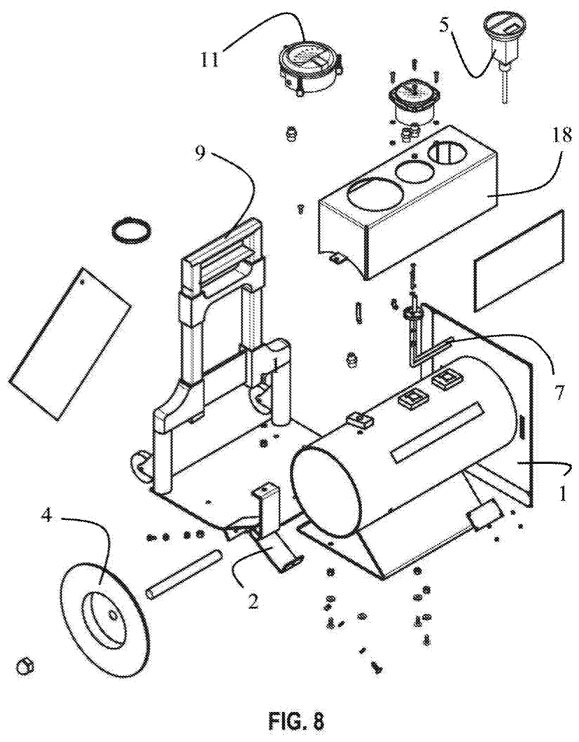

In FIG. 2, illustrated is a primary hose 60 connected to an adaptor 62 an opposite side of the adopter connects to preconditioned air tester 50. In FIG. 3, illustrated is preconditioned air tester 50 with air pressure gauge 11, air speed gauge 52 and temperature gauge 5. In FIG. 4, illustrated is preconditioned air tester 50 connected to primary hose 60 with primary hose 60 is positioned in a “u” shape pattern. In FIG. 5 illustrated is in line preconditioned air tester 70. In FIG. 6 illustrated is in line preconditioned air tester 70 with pendant gauges 80. One end of the in line preconditioned air tester 70 is connected to primary hose 60 and the opposite end of the in line preconditioned air tester 70 is connected to the aircraft's external connection port 72. In FIG. 7 illustrated is preconditioned air tester 50 with aircraft wheel chocks 82 to hold the preconditioned air tester 50 in place during testing. In FIG. 8 illustrated is body weldment 1 opposite welded web 2 and cover 4. Cart 9 is shown. Cover 18 holds air pressure gauge 11 and temperature gauge 5. Static pitot tube 7 is shown.

Preconditioned Air Tester Set Up 1. First unroll the primary hose from the hose cart, basket, or reel for the PCAir unit. a. The hose must be completely deployed before testing. b. It is recommended to lay the hose in a “u” shape pattern to reduce the distance of the tester from the PCAir unit and to utilize less space on the ramp. 2. Remove restrictions from the hose system. The accuracy of the Preconditioned Air Tester is dependent on the reliability of the hose from the PCAir unit to the tester. Any sort of restriction below will cause a reduced reading at the tester. a. Length of the hose design is normally recommended to be 65 ft. and this is the preferred length for testing but longer lengths of hose sections may be already installed from the unit remember longer length than suggested by the PCA manufacturer may produce lower air flow and temperature reading being below desired readings. POU unit may need to be adjusted, set-up or repaired to achieve the correct and required aircraft input temperature and air flow, speed or velocity. b. Air leakage at hose connections and fittings c. Twists and kinks in the hose d. Extensions carts used to make the hose longer Hose connection to the cart does not require disassembly and connects to the cart and cart connection hose adaptor to the test devise. Aircraft types take a longer hose i.e. 120′ for MD-80's or RJ-aircraft and test readings may vary refer to POU manufactures manual for desired readings. e. Hose reducers and flex hose sections 3. Run the PCAir unit briefly to help remove kinks and twists from the hose and to clear dirt and moisture from the hose. 4. Examine the Preconditioned Air Tester a. Remove any debris from the inside of the tube b. Examine all gauges to make sure the air speed and pressure gauge are reading zero and the temperature gauge is reading correctly c. Back the restrictor cone as far as possible from the tube end. i. This will allow maximum air flow thru the device on start up ii. There should be an approximately 2″-3″ gap between the end of the tube and the surface of the cone face. 5. Connect the adapter to the Preconditioned Air Tester a. Fully secure the adapter to the front mounting plate b. Check for a tight seal to reduce air leakage. Restrict the movement of the adapter at the end of the hose, to prevent the hose from moving during start of PCAir unit causing the hose to whip. a. The flow of air thru the tester and the restriction of air can cause unexpected forces on the tester. b. The recommended method of securing the tester is to place a set of aircraft wheel chocks over the PCAir adapter during testing. c. Additional methods of securing the tester maybe used, but the tester must be always secured during testing.

Testing 1. Start the PCAir unit as per the manufacturers documentation a. Select the aircraft mode you want to test. For example: i. Commuter ii. Narrow Body iii. Wide Body b. Air temperature discharge mode i. Vent ii. Cool iii. Heat 2. Set the static pressure of the tester. This feature of selecting the discharge mode is not always provided on the POU pendant control station and a certified trained unit technician/mechanic will have to select the required mode in the units internal control cabinet. c. Look at the Inches of Water Column Gauge d. Turn the adjustment cone, so that it reduces the gap between the cone and the tube. This will increase the static pressure of the system, showing an increase on the Inches of Water Column Gauge. NOTE: If the airspeed gauge is reading above 140 MPH quickly open the cone to prevent damage to the gauges. e. Continue to turn the cone until the gauge reads at the appropriate pressure examples of the suggested back pressure settings being i. Commuter—Heating Mode—4 to 8 Inches of Water ii. Commuter—Cooling Mode—8 to 12 Inches of Water iii. Narrow—Heating Mode—10 to 15 Inches of Water iv. Narrow—Cooling Mode—15 to 20 Inches of Water v. Wide—Heating Mode—15 to 25 Inches of Water vi. Wide—Cooling Mode—20 to 30 Inches of Water d. Do not adjust the static pressure above the maximum level on the Inches of Water Column Gauge, permanent damage may occur. e. Leave the adjustment cone in position once the appropriate pressure has been reached. This roughly equals the load placed on the PCAir unit by an aircraft of appropriate size. These values are not for a specific model of aircraft but are based on the average range for aircraft of each class. 3. Read the airflow through the tester a. Look at the Airspeed Gauge b. The suggested testing airspeed gauge should read: i. Commuter—Heating Mode—30 to 50 MPH ii. Commuter—Cooling Mode—50 to 75 MPH iii. Narrow—Heating Mode—60 to 75 MPH iv. Narrow—Cooling Mode—80 to 110 MPH v. Wide—Heating Mode—80 to 100 MPH vi. Wide—Cooling Mode—120 to 130 MPH Compare the value from the gauge with the conversion chart included in this manual and on the tester for an estimated CFM of the unit. The airspeed/airflow value is an estimate only and does not consider environmental conditions or flow disruptions caused by the tube.

d. If the airspeed gauge is not reading in the appropriate range for the setting consult the OEM manual for the PCAir unit. Making adjustments to the unit can only be made by an authorized and trained technician for the unit. 4. Reset the static pressure and continue through the airspeed test steps anytime a change has been made to the PCAir unit.

5. Temperature Testing a. The digital thermometer on the tester is used to determine the output temperature at the end of the hose. b. This is used to determine if the PCAir unit is heating or cooling as required. c. The temperature on the gauge will not match the discharge temperature setting of the PCAir unit. The air will experience temperature loses depending on the length of hose, type of hose, number of connections, and atmospheric conditions. Troubleshooting 1. Inches of water column gauge is not showing any static pressure. a. Close the adjuster cone to try and build pressure. b. Check that that the hose connections are tight and there is no air leaking around the line c. Verify that there is no debris blocking the pressure port, tube, or inlet to the gauge d. Duplicate pressure port in gauge is not plugged e. Diaphragm has ruptured due to over pressure 2. Inches of water column gauge is stuck at a reading leveling a. Debris in the pressure port, tube, or inlet to gauge. Clear debris. b. Moisture in pressure port, tube or inlet to gauge. Gently tap gauge and tilt tester to drain moisture. 3. Airspeed gauge not reading or stuck in position a. Check that that the hose connections are tight and there is no air leaking around the fittings or pitot tube b. Verify that there is no debris blocking the pitot tube, fittings, or gauge ports c. Moisture in pitot tube or pressure ports. Tilt tester and allow time for gauges to drain. 4. Airspeed gauge reading above 140 MPH a. Blockage or leak in static portion of pitot tube or static port on gauge b. Lack of static pressure in system. Turn cone to increase static pressure. 5. Temperature gauge blank a. Place in light to charge b. Refer to product instruction manual 6. Temperature gauge reading incorrectly a. If a small correction is need. Addition of ports in the tube for using additional test equipment, i.e. Manometers, Hot Stick/wire devices and other flow and velocity devices have been included in this end of hose device.
While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A end of line air flow tester comprising:
a preconditioned air tester with a cart to provide modality to the preconditioned air tester, a cover with an air pressure gauge, air speed gauge and temperature gauge, an adjustable cone or restrictor plate opposite a body weldment along a tube.

2. The end of line air flow tester of claim 1 wherein the body weldment connects to a primary hose at the primary hose discharge end by an aircraft connector.

3. The end of line air flow tester of claim 1 wherein the cover is an instrument panel.

4. The end of line air flow tester of claim 1 wherein the cover provides separate gauges.

5. The end of line air flow tester of claim 1 wherein the cone is adjustable the cone located at a discharge end of the tube for providing the needed air flow restriction back pressure on the end of line air flow tester and a discharge hose to accomplish testing of the end of line air flow tester's functions

6. An in-line air test device comprising:
a first end of the in-line air test device adapted to be connected to an aircraft's external connection port, a second end of the in-line air test device is connected to a primary hose using a hose end connector on the hose, a device body is between the first end of the in-line air test device and the second end of the in-line air test device, the body has connections for air speed, air temperature and air pressure gauges.

7. A method for determining, measuring and recording conditioned air pressure, air flow and air temperature being supplied into the aircraft's external connection port from a preconditioned air unit comprising:
attaching an air test device to the end of a primary hose turn on the preconditioned air unit;
measuring and recording air flow at the end of the primary hose in H20/inches the air flow is supplied to internal ducting of an aircraft at the the aircraft's external connection port;
measuring and recording air speed; and
measuring and recording actual air temperature that is entering the aircraft internal ducting.

8. The method of claim 7 wherein the air test device is an line test device or a pendant station.

9. The method of claim 7 wherein the air test device is end of line air flow tester.
